(19) United States
(12) Patent Application Publication
(10) Pub. No.: US 2013/0035976 A1
(43) Pub. Date: Feb. 7, 2013

(54) PROCESS MINING FOR ANOMALOUS CASES

(71) Applicant: Scott BUFFETT, New Maryland (CA)

(72) Inventor: Scott BUFFETT, New Maryland (CA)

(21) Appl. No.: 13/566,206

(22) Filed: Aug. 3, 2012

Related U.S. Application Data
(60) Provisional application No. 61/515,479, filed on Aug. 5, 2011.

(51) Int. Cl. G06Q 10/06

(52) U.S. Cl. 705/7.26

(57) ABSTRACT

A method for process mining comprises accessing a base model for a process, generating a set of rules characterizing relations between tasks in an event log, specifying tasks that together fail to complete an instance of the process, and applying an abductive reasoning process using the set of rules and the specified tasks to identify one or more ways of completing the process instance. The method can output ways of completing the process instance that are not consistent with any single trace within the event log corresponding to a completed process instance. The method can be used for operation support, monitoring and guiding operation support, or assisting in sorting of events by case.

### FIELD OF THE INVENTION

The present invention relates in general to process mining, and in particular to identifying potential workflows for a sequence of events that does not correspond with any case in an event log, and for which there is no explicitly encoded rule.

### BACKGROUND OF THE INVENTION

Process mining is a data analysis technique that extracts business process information from event logs. Process mining is usually used when no formal or sufficiently accurate and reliable description of the process is available. The large and growing number of activities being suitably monitored to provide logs suitable for process mining is growing, and process mining is evolving to be relevant to a wider variety of activities. Business process management technologies in general, and workflow systems in particular, are becoming more pervasive in a variety of settings. To date, event logs recorded by information systems have been mined extensively to characterize and describe processes, for example, for discovering process, control, data, organizational, and social structures and relations. For example, the audit trails of a workflow management system, the transaction logs of an enterprise resource planning system, and the electronic patient records in a hospital, can be used to discover models describing processes, organizations, and products, with a view to determining how the process can be made more efficient. Process mining can also be used to help track and analyze typical processes within a company. As the technology continues to mature, broader usages of process mining are beginning to emerge.

There are various algorithms known in the art for constructing a model from an event log. Many research efforts in process mining focus on flexibility. A model that is flexible will capture more situations than are present in the past data, and is therefore still useful in the face of relatively minor deviations. This is accomplished by “under-fitting” the model, by keeping it as general as possible without losing too much specificity. Much of the previous work in this field has been preoccupied with striking an optimal balance between flexibility and specificity.

One application of process mining is to compare event logs with some a priori model to assess conformance to some prescriptive or descriptive model. A prescriptive or normative model is one which formulates rules to indicate how a flow should go given preconditions, and is typically encoded as an expert system, i.e. with knowledge of experts in the field—having the advantages and limitations of human understanding and its expression, or by taking a descriptively derived model for this purpose. A descriptive model is one which attempts to uncover the rules implicit in the logs, as if to read the logs assuming each entry is correct. In this art, most of the examples of prescriptive models are more correctly proposed or exploratory prescriptive models, in that they are used to test a hypothesis regarding how process events are related, and so they do not apply retrospectively to a log.

For example, WO 2010/045143 to Freire et al. teaches an evolutionary workflow processing system for systematically capturing detailed provenance and streamlining data exploration. The number of logically possible partial workflows, in even moderately complicated process flow systems is high enough to make it almost pointless to try to cover off every conceivable case with a complete workflow, although this is ultimately what is viewed as required by Freire et al.

Recently, process mining has been applied for operational decision support, unlike previous off-line applications. For example, see van der Aalst et al. Beyond Process Mining: From the Past to Present and Future, which focuses on individual process instances (cases) that have not yet completed, noting that process mining can be used on-line to: check conformance, predict the future, and recommend appropriate actions. More specifically, time-based operational support can detect deadline violations, predict the remaining processing time, and recommend activities that minimize flow times.

Applicant has previously disclosed an approach to process mining referred to as abductive workflow mining [The 4th Workshop on Business Process Intelligence (BPI 08) in conjunction with Business Process Management (BPM 2008). Milan, Italy. Sep. 1, 2008. NRC 50393, and The International RuleML Symposium on Rule Interchange and Applications (RuleML 2008). Orlando, Fla., USA. Oct. 30, 2008. NRC 50392], the contents of both are incorporated herein by reference. Abductive workflow mining was disclosed in the context of solving a problem relating to compliance monitoring.

Total accuracy of process models is not usually desired, for a number of reasons, including the complexity involved in modeling processes perfectly and the limits of computer resources, but also expressly so that the model is user comprehensible. Because of the inaccuracies of the process models, assessing compliance of a trace to a mined process model tends to raise an unnecessarily large number of false alarms. The abductive workflow mining presents a way of identifying infractions of only critical activity, as opposed to any model process violation. Thus if the critical activity was found to have occurred, only a corresponding set of circumstances would need to be checked for conformance, rather than comparing the entire trace against the process model, which was likely to contain more errors. The notion of abductive workflow was conceived as a way for identifying the corresponding set of circumstances for a given critical event or set of events in a process. Specifically, an abductive workflow for any given critical activity is defined as a workflow such that any execution sequence through that workflow would necessarily imply that the critical activity would occur. Thus the stronger notion of implication, rather than consistency, was chosen. So if the abductive workflow activity was deemed to have taken place, since we know that this activity would necessarily cause the activity to occur, there should be no cause for concern, even though the activity as a whole may not have perfectly adhered to the accepted process model. Accordingly, these papers focus on the identification of rules that necessarily explain or imply an observation regarding the patterns of events in the log. Advantages of this system were that the size of workflows could be significantly reduced, and is particularly applicable to compliance checking.

As these process mining technologies are applied in less traditional process settings, such as in hospitals, it is becoming apparent that current process mining techniques are inadequate. One pervasive assumption of process mining that is being challenged, is that the processes to be mapped are “routine”, high frequency, operations, such as handling a new loan application in a financial institution, or a supplier processing a new order request. New adopters of process mining applications are interested in modeling processes that are (1) more dynamic and (2) less frequently executed. Accordingly, current systems that use process mining to analyze data on past activity to generate or update process models for incomplete cases, are liable to fail due to the paucity of data to build a robust model that captures the many different processes, and or variations. Thus an overall process model constructed entirely from existing data may be found to omit a number of known cases that might be desired for inclusion, or in the case of real-time execution, a user seeking guidance may find that their case is not consistent with any state in the process model, rendering the model useless. Thus while the prior art recently was preoccupied with the morass of data that required algorithms to navigate, the problem going forward will be paucity of data in relation to the growing complexity or dynamics of processes being modeled.

Accordingly there is a need for a technique for analyzing an event log to automatically derive candidate workflows that are not prescribed by a specific previous case, and especially for anomalous cases (I.e. cases that are inconsistent with any case in the event log). These are particularly valuable for event logs that are not rich enough to cover all possible completions.

### SUMMARY OF THE INVENTION

The present invention arose from the realization that the previously developed abductive workflow mining can be utilized to generate prescriptive workflows, including workflows that are not expressly covered by any particular case in the event log. Analyzing an event log using abductive reasoning to generate abductive rules, with a rule-based process modeller permits a user to identify a state, and derive a prescribed workflow for a case in the identified state. The abductive rules will generally be consistent with the previous cases in the event log matching the identified state, but if the identified state does not match any previous case (anomalous), abductive rules will still prescribe a workflow that is a consistent extension of the cases in the event log.

So, while the previous papers on abductive workflow mining found explanations for activity that preexisted in the data, it has subsequently been found that similar explanations can be used prescriptively. Thus abductive reasoning can propose a new situation, such as a sequence of actions or a complex segment of activity, including concurrent activity and/or choice points, and by analyzing the abductive relationships in the data, a full process model can be constructed around the proposed activity that includes tasks that would necessarily cause the activity to take place, and indicate how that activity should be executed as well as how to continue and complete the activity involved in a process instance during operation.

In accordance with the present invention a method for process mining is provided, the method comprising: accessing from in a digital memory in computer-readable format, a base model for a process that differentiates permissible sequences of tasks within a subject process from the impermissible; accessing a set of rules characterizing relations between tasks in an event log associated with the process, to define a rule base; receiving a specification of a set or sequence of tasks that together fails to complete an instance of the process according to the base model; and applying an abductive reasoning process using the set of rules and the set or sequence of tasks to identify one or more ways of completing a process instance including the set or sequence of tasks, by: identifying each rule in the set that would entail one or more tasks in the process instance, and adding to the process instance tasks, that according to the identified rules, explain the tasks in the process instance. The one or more ways of completing the process instance identified by the abductive reasoning process may include at least one way of completing the process instance that is not consistent with any single trace within the event log corresponding to a completed processing instance, unlike any known prior art system.

The set of rules may incompletely characterize relations between tasks in the event log in that the rules are non-exhaustive, and the rule base may include proportionally more rules relating relatively few tasks than all rules implicit in the event log, and for example may include mostly rules relating exactly two tasks. The rule base may include proportionally more rules relating tasks that are separated by less than a mean separation of tasks than all rules implicit in the event log. The rule base may include user-defined rules.

Applying the abductive reasoning process may comprise constructing an initial model for the specified set or sequence of tasks as per the received set or sequence; growing the initial model by identifying each rule in the set that would cause, at least in part, the specified set or sequence if an abduced task, not in the initial model, were added, and adding such abduced tasks until a sufficiently explained model is provided, or no further explanations are available; and modifying the sufficiently explained model by modifying the model to make it more consistent with respect to the set of rules, for example, iteratively.

The method may further comprise generating a graphical model of the process defined by the event log, wherein adding abduced tasks to grow the model comprises inserting the added abduced task into the model in a way that is most consistent with the rule base.

A computer comprising is provided having a memory and processor, the memory storing in computer readable program instructions for directing the processor to implement a method as described above.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of a flow chart showing principle steps involved in a method of analyzing a case instance in accordance with an embodiment of the present invention, to respond to a query;

FIG. 2 is a schematic illustration of a flow chart showing principle steps involved in a method for maintaining a model, that permits case analysis in accordance with an embodiment of the present invention;

FIG. 3 is a schematic illustration of a flow chart showing principle steps involved in a method for updating a process model, in a manner that permits rule-based user interactions and simplified analysis;

FIG. 4 is a typical Petri net generated from the example event log; and

FIG. 5 shows a series of steps in the formulation of a workflow model for a case that includes or begins with MN.

### DESCRIPTION OF PREFERRED EMBODIMENTS

The present invention provides methods for generating candidate workflow models (or equivalent suggestions in other forms) for cases other than those which are consistent with traces within an event log (i.e. anomalous cases), for example to provide the candidate process model as a suggestion for operational decision support, or to facilitate user-based enrichment of process models. Resulting process models provide options and analysis for potential ways to proceed other than those ways that are provided for by way of enumeration within an event log, or by generalization on this provided by representing the traces in the log with a Petri net, for example. The candidate process models are most conspicuous in that they provide suggestions even when the event log has no matching traces that fit the current situation, e.g. for anomalous cases, but even if the case does match a trace in the log, the present invention may provide options for the case other than those ways that were already followed by the traces. For example, a healthcare worker faced with a unique situation in the care of a patient could be automatically presented with a number of options on how to best proceed, completing the so-called “careflow” of the patient. The worker could assess the expected level of success of each option, the level of difficulty, the time to complete, etc., to make an informed decision on how to proceed in the face of uncertainty. Even if the worker elects a next step that is other than suggested, the variance will become part of the event log, and may impact the abductive rules of subsequent iterations. The purpose of the present invention is to assist the worker in providing relevant hypotheses to consider, even if the case has no precedent. In other applications, the process may be substantially automated. If the process is important to complete quickly, whether correctly or incorrectly, in the face of an event log that does not cover all possible situations, a best choice can be made and documented using the present invention.

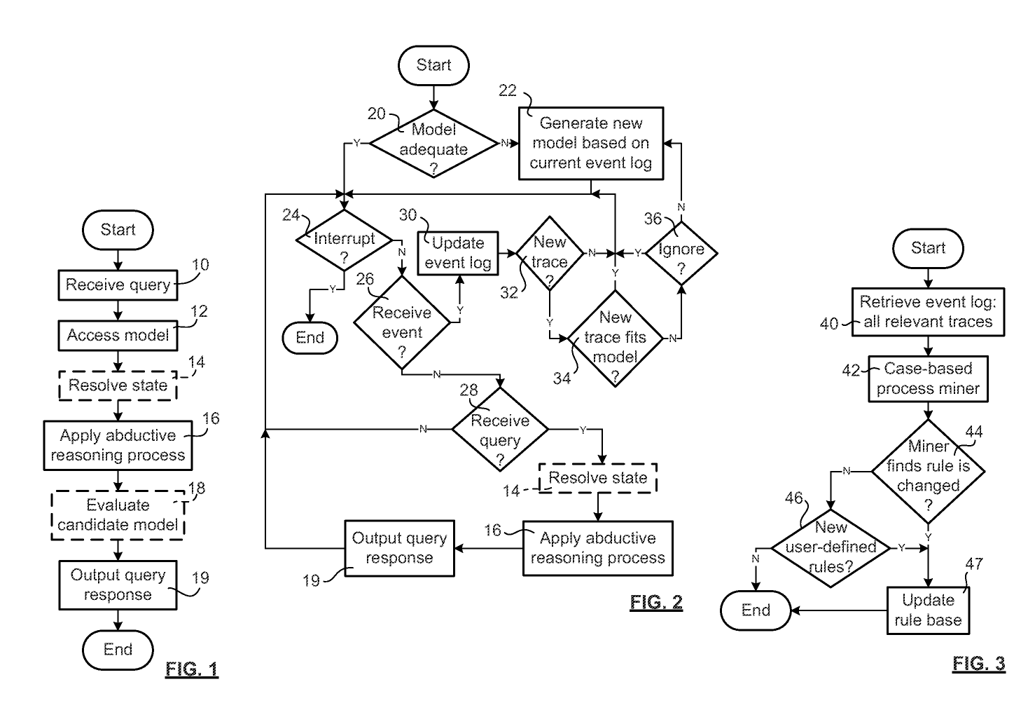

FIG. 1 is a flow chart showing principal steps in a query-based method for abductive process mining, in accordance with an embodiment of the present invention. In step 10, a query is received, the query indicating a case for which a candidate workflow is desired. The case may be of three general sorts: hypothetical, actual, or partially identified. Hypothetical cases may be presented in order to determine what the abductive process miner will suggest in particular cases, for example, in order to create additional rules to suitably guide the abductive process miner, and/or to revise the workflow, which may be based on the event log. Actual cases are sequences of events that have occurred, but are not completed traces, as the process instance has not concluded. Finally, partially identified cases are sets of events that do correspond to a same process instance, that are expected to further be identified with one or more other events in the log, but it is not known which events in the log to consider first.

Thus the invention permits application in situations with substantial uncertainties. If the event log is expected to be complete and up-to-date, with each event correctly associated with its case a given duration after the last event, at least with respect to all events that are being tracked by the event log, the present invention can be used for actual cases. In general, most process flow applications do not track certain events, and these events may be essential to determining correct processing of cases. These excluded events may be inferable from events within the log, in certain situations, and not others, and may be verified, for example, with recourse to non-electronically available materials, in some situations. In some applications, it may be unknown whether and when event records will be updated with respect to a particular case, and a decision may be required immediately, thus requiring an output under uncertain circumstances. Furthermore, the query's source (human or machine) may possess information or recourse to materials (electronic or otherwise) relevant to the case that the abductive workflow miner does not.

In step 12, the abductive process miner obtains the current process model for the process. This may involve, under suitable circumstances, (re)generating the process model from the event log, in a manner known in the art, or in the manner described below with reference to FIG. 3, for example.

In some applications, it may be desired or necessary to resolve a state of the case, for example, with recourse to the event log, and one or more other electronically accessible materials, including some to which the source of the query may not have access. State resolution (step 14) may further simplify or alter the state of the case queried, under certain circumstances. For example, if the case represents a process instance that was noted to be problematic for one reason or another, and for this reason a variety of usually incongruous tasks were “tried”, and found to be incompatible with completion of the case, an algorithm may be invoked to analyze the case log (i.e. the events in the event log that are associated with the case) to determine what is essential to analyze in order to make the suggestion regarding the sequence of tasks that would complete the case. Unintended events may arise as a result of backtracking: when a user has completed some activity before deciding it was not the best course of action, and instead returns back to a previous decision point and makes a different choice. State resolution algorithms are expected to be heavily dependent on the application to the extent that generalization of these algorithms is not attempted. With a clear appreciation of the individual application, it is within the purview of the person of ordinary skill in the art to design such a module if desired.

The case is then, at step 16, analyzed by an abductive reasoning module that takes the (possibly incomplete) case log, and the process model, and abduces rules regarding what sequence of events would explain the observed or hypothetical case specified in the query (as amended by the state resolver, if applicable). The abduced rules, to the extent that they are applicable in the case, are used to identify necessary conditions for the abduced process workflow, and a process flow is produced from the necessary conditions, that is sufficiently consistent with the event log. While various algorithms for abductive reasoning are envisaged, applicant currently assumes a structure involving a set of user-defined rules, a set of deduced rules from the event log, and a process for identifying the necessary conditions in a first pass through the complete rule set, followed by a process which iteratively modifies the existing process flow and the deduced rules, to approach consistency with the abduced process workflow, although it is possible to avoid the generation of explicit rules entirely by retaining only the event log.

Evaluation of the abduced workflow may be performed in step 18, to 1) rank a plurality of abduced workflows, if more than one is identified; 2) provide a confidence measure for the one or more abduced workflow, given the event log; or 3) determine how the abductive workflow meets constraints other than those defined by the process model. For example, if the suggested action is expensive, and the confidence measure is low, the process may be suspended pending review, rather than sent in response.

In step 19 a response to the query is returned. The response may be a suggested course of action including only a small part of the abduced workflow, may be the whole workflow, may be the workflow as well as the rules generated and/or used to generate the abductive workflow, or may further include the weights or confidence measures of the rules, depending on how deep an understanding of the system the source of the query is expected to have, and how much responsibility the source takes for the actions taken. The whole workflow is preferably included if the source has recourse to materials unavailable to the abductive process miner, that might permit the source to determine the specific trace through the abductive workflow to follow.

FIG. 2 is a flow chart showing principal steps in a query-based method for abductive process mining, integrated with a continuous process for updating the process model, in accordance with an embodiment of the present invention. The integrated abductive process miner begins, and determines (step 20) whether a process model is adequate for the present event log. If not, the process model is (re)generated at step 22. Unless interrupted (step 24), the integrated abductive process miner continually determines whether a notice of an event is received (step 26), and if not, determines whether there is a query (step 28). When interrupted the integrated abductive process miner may end. When a new event notification is received, the event log is updated (step 30).

Event logs are known in the art and may take the form of a variety of inputs that are tracked in respect of one or more known tasks, as applied to respective cases. Records in an event log can indicate information regarding a number of attributes associated with an event, including date/time, operator ID, machine ID, etc., but will always contain information regarding the “case” and the “task”, where the case refers to the process instance to which the entry belongs, and the task refers to actual action being executed. The (maximal) sequence of tasks extracted from a time-ordered event log that refer to the same case thus yields an example execution of a process, known as a trace.

It is generally immaterial whether the event log receives the notification from the integrated abductive process miner, from another process that identifies the case with the task (for example) or from the sources directly, and equally whether the integrated abductive process miner receives the notification from the event log, or from the sources directly, or via another process. It is determined whether the event completes a trace out of a set of events in the log for a given case (step 32), whether any such new trace fits the existing model (step 34), and whether, for one reason or another, the new trace is not to be followed or covered by the process model (step 36), so that if a new trace is found, and it does not fit the present model, and it is not a trace to be ignored, the integrated abductive process miner generates a new process model (step 22), and otherwise the process returns to step 24.

If, at step 28, a query is detected, an abductive workflow is generated by (optionally) applying state resolution (step 14), followed by abductive workflow generation (step 16), and response to the query (step 19), as described above. Following the response, the integrated abductive process miner returns to step 24.

FIG. 3 schematically illustrates a preferred method for generating the process model, as per step 22, and optionally as a part of step 12, or under other conditions. This method maintains three levels of descriptions: an event log; a model; and a set of rules. One advantage of maintaining this list of rules, is that even if the workflow model gets rather complex, sufficient characterization of the traces is provided by the rules to permit quick identification of the traces that fit the model (as in step 34). Furthermore the traces that are new according to the event log, may not be new to the model, for example if user-defined rules have already been specified that countenance the new trace. Thus the model is revised less frequently, the more accurately the rules (both those extracted from the event log, and those specified by the user) cover the eventual traces. Another advantage is that it simplifies abductive workflow generation 16, by providing a readily determined list of pre- and post-conditions that require (assuming the rule is correct), any one or more tasks or sequences of tasks. A final motive for recourse to this rule-based description of the base model is the ease with which it accommodates user-defined rules. Rules are a relatively intuitive format for users to impose restrictions on the workflows, for example to augment a relatively sparse event log, or guide interplay between the rules based on clearly known relations between traces that will be completed and those that will not. Furthermore, it may be preferable to permit user-defined rules, user-defined weighting of rules, and number-of-instance based weightings of the rules for certain applications.

The process begins, and at step 40, the current log accessed. Each completed process instance is defined by its trace. All incomplete cases and extraneous data are omitted, and, in some cases, all traces that have few executions, or have been marked, are ignored. For example, any trace that contradicts a user-defined rule may be excluded and flagged for user-review. Alternatively, the process may determine whether the user-defined rule was defined as universally applicable to a set of tasks that were instantiated at the time the rule was defined, and suggest a revised rule applicable to the previously instantiated set of tasks, but not to one or more subsequently instantiated tasks. If so, the revised rule may be flagged for user review, or may be added to the model immediately. Typically rules that were extracted from the log are viewed as less reliable than user-defined rules, however it may be further desirable to weight rules according to the frequency with which the rules were observed in the log, so that a small number of instances of an unusual sequence of events, does not result in a change in a well confirmed rule, although this may well depend on the application.

The remaining list of traces is then input for step 42, which uses known process mining techniques to generate a base model. The base model is preferably a Petri net, or a like graph representing the sequences of the events that are manifested by the examples in the event log. Typically, when generating Petri nets, one of a handful of procedures are used, that are typically selected to minimize superfluous arcs and place nodes to make choices “non-free”, and to avoid duplication of task nodes, to achieve a model that is suitably “underfit”. Naturally other representations can be used, such as: Yet Another Workflow Language (YAWL) [W. M. P. van der Aalst and A. H. M. ter Hofstede. YAWL: Yet Another Workflow Language. Information Systems, 30(4):245-275, 2005], Fuzzy Models [C. W. Gunther. Process Mining in Flexible Environments. PhD thesis, Department of Technology Management, Technical University Eindhoven, 2009], Colored Petri Nets [K. Jensen, L. M. Kristensen, and L. Wells. Coloured Petri Nets and CPN Tools for Modelling and Validation of Concurrent Systems. International Journal on Software Tools for Technology Transfer, 9(3-4):213-254, 2007], or Hidden Markov Models [Gil Aires da Silva, Diogo R. Ferreira, Applying Hidden Markov Models to Process Mining, in A. Rocha, F. Restivo, L. P. Reis, S. Torrão (eds.), Sistemas e Tecnologias de Informação: Actas da 4^{a} Confer\tilde{e}ncia Ibérica de Sistemas e Tecnologias de Informação, pp. 207-210, AISTI/FEUP/UPF, 2009]. While it will be noted that a Petri model, for example, does suggest possible traces that are not, in fact, supported by examples within the event log, and these are produced in a systematic manner, the number of these possible traces is small, and their specific constraints do not correlate well with what traces are actually possible, in many applications.

Case-based process mining 42 may be performed by constructing the model anew with the updated event log, or may consider only a sub-model that is, limited by the case that has just completed. E.g. a previous version of the model may be compared with the new trace to identify the sub-model. The submodel may be regenerated by revision of a stored worksheet that describes how the model was generated, or may simply regenerate a submodel from scratch, with a reduced set of elements (e.g. tasks and places) that are relevant to the new trace.

The case-based process mining 42 may involve generating a base model for the remaining list of traces, followed by modification of the base model to fit user-defined rules of a current rule base. The rule base may be a list of event-condition-action (ECA), or task-successor rules. Non-exhaustive methods for deriving these rules from the log, and limits on how many rules are generated, may vary with the application. In general, a rule change may arise from a novel trace, either in that the trace conflicts with one or more existing rules, or that it suggests another relation that was not previously extant in the cases of the log. For example, a first case F to complete that includes a new task N, such as a case that is similar to a previous case P but has N in place of old task O, may prompt a change in existing rules regarding O, requiring the rule to now specify O or N, in place of O. Other new rules regarding the relation between N and each of the other tasks in F may also be created. Some of these may well be revised upon further case completions that implicate N. Any changes to the rule base given the new trace(s) in the log (as identified at step 44), or any update to the rule base by virtue of a change in user-defined rules (as identified at step 46) cause the rule base to be updated in step 47. The rules/changes to the rule base may be computed concurrently with the case-based process mining 42, or as a separate process after the base model is complete (as shown). The examination of the new base model to determine whether a rule update is appropriate may be limited to an examination of a submodel that is relevant to the new trace(s).

While the examples given show the analysis performed in a query/response structured environment, it will be appreciated that the same can be performed in a more seamless interactive manner by a software interface. This option may be preferred for analysis of the system which may make greater use of hypothetical cases, or in cases where the purpose is to associate events with their cases. The software interface may further permit the user to enter user-generated rules, or special traces, or to weight or rank the rules and/or traces in the abductive process miner.

### Example

Consider an event log consisting of the following set of traces, where each uppercase letter represents a respective task:

| | | | | |
|---|---|---|---|---|
| AFGRYZ | AGFRYZ | BHIMPRYZ | BJMPQZ | BKMPRYZ |
| BKLPRYZ | BKLVYZ | CNSTWYZ | CNPRYZ | CNSUYZ |
| COPQZ | COVYZ | DOPQZ | DOSTWYZ | DOVYZ |
| ENSTXYZ. | | | | |

A typical process mining algorithm generates a process model from these traces having similar content to the Petri net shown in FIG. 4, although some variation is expected depending on the specific algorithm used to generate the model. The illustrated Petri net has a currently desirable form having no redundant tasks, and no extraneous arcs, places, or transitions. It will be noted that the joint requirements for F and G, with no preference for order is represented by the dummy transition having two input places succeeding F and G, and that the remainder of the arcs are serial (single token input, single token output).

It will further be noted that the Petri net does generalize on, and mask some specific features of, the event log. For example, the Petri net suggests that EOPQZ is equally permissible as DOPQZ, which may not be a reliable inference, as nothing in the log suggests D is substitutable for E. Indeed traces that begin with E always have N and always have X, whereas traces that begin with D never have either, in the log to date. As noted above, the manner in which Petri nets generalize on the event log, does not necessarily align with what the actual possibilities are for the process. In some processes it may be far more likely that A followed by F and G followed by one of Q, V and U followed by Y and then Z (each of which is not permissible by the Petri net) are possible completions, in comparison with EOPQZ.

The present example looks at how candidate models can be built automatically, based on the above information, for a case (i.e. a running, currently unfinished process instance, or hypothetical process instance) that does not fit the currently prescribed workflow. Such an instance will not follow a valid firing sequence in the Petri net beginning at the start node, and will not agree with any specific trace in the event log. For example, the sequence BHI constitutes an unfinished process instance that fits the model, since the process can legally start with B, followed by H, followed by I. One can easily see that the next permissible action in the sequence is either L or M. This example will examine a situation that does not fit, namely MN. In such a situation it may be very unclear how one should proceed, particularly due to the fact that there appears to be a critical decision point following M and N (as to whether one uses P, S or V). A new process model that includes this new scenario is constructed based on the patterns inherent in the event log. To construct this new model, we follow the following steps: 1) create a list of rules that are implicit in the event log; 2) take all abductive rules that explain M or N's application, and build an initial workflow that explains each task, and each task that is added to the workflow to explain one or more other tasks; and 3) iteratively close the model according to the rules to avoid contradiction where possible.

1) Logical rules are first discovered in the set of traces. While various notation can be chosen, applicant uses task-successor rules of the form: p₁ [symbol] p₂ [symbol] . . . pₙ→q₁ [symbol] q₂ [symbol] . . . qₘ, which stands for the expression “If p₁ and p₂ and . . . and pₙ happen in that order, q₁ or q₂ or . . . or qₘ will have to follow (eventually)”. Inversely, rules to indicate that certain activity necessarily occurs before other activity can be written as q₁ [symbol] q₂ [symbol] . . . qₘ←p₁ [symbol] p₂ [symbol] . . . pₙ. The “and” [symbol] and “or” [symbol] symbols are typically omitted. Since → and ← are also used for order operations, we enforce that premises in each rule are ordered. For example, if p₁ [symbol] p₂ (precedes), p₂ [symbol] p₃, . . . and pₙ₋₁ [symbol] pₙ, then p₁ [symbol] p₂ [symbol] . . . pₙ→q₁ [symbol] q₂ [symbol] . . . qₘ can be written as its logical equivalent p₁→(p₂→( . . . (pₙ→q₁ [symbol] q₂ [symbol] . . . qₘ)) . . . ). Thus, having regard to the above-stipulated event log, it will be noted that M→P, and A,B,C,D,E←Z, are both well-formed rules that are consistent with the event log, i.e., whenever M is present in a trace, P will follow at some point after, and if Z occurred, A or B or C or D or E occurred before it.

Brute-force algorithms for finding a complete set of rules are typically not desirable, because of the duration and complexity of the rules, and because of the unintelligibility of the majority of rules, along with the fact that many rules are special cases of a few stronger rules. Generally, the rules that have fewest terms, are the strongest rules. For all of these reasons, Applicant prefers 1) discovering an initial set of rules for tasks that appear close together in traces, followed by performing binary resolution to infer new rules to augment the rule base.

A set of “task successor” rules are constructed from the event log. Specifically, the task successor rules govern how tasks are directly succeeded by other tasks. There are two types of task successor rules mined according to the present example (although other types can be used alternatively or additionally): disjunctive and conditional. Disjunctive task successor rules take the form: p→q₁ [symbol] q₂ [symbol] . . . qₘ, (i.e. task p is always followed by one of q₁, . . . , qₙ.), while conditional rules have the form E→(C→A) and govern exactly which task follows another, given that some particular task precedes it. The former can be extracted by a simple linear-time inspection of the log. The latter are desired because, while any of q₁, . . . , qₙ might follow p, it may be the case that it is always q₂ whenever p is preceded by r. Event-condition-action (ECA) rules are of suitable form. Each ECA rule indicates that the occurrence of a particular event E will cause the specified condition C to imply the specified action A. ECA rules are mined from the log by identifying, for each task C, pairs of tasks (E, A) such that (1) ECA appear consecutively in at least one trace, and (2) for any trace containing C where C is not directly followed by A, E does not appear anywhere in the trace before C. Whenever this is the case, we know that the presence of E triggers C to cause A, and thus the rule is asserted.

So in the example log, via the disjunctive rules G is followed by: F or R, yielding G→F,R. Likewise one disjunctive rule is produced for each term (task). Some special cases of only one task following a given task would be noted as D→O, E→N, I→M, R→Y, M→P, etc. The ECA rule mining, when applied to G would consider only AGF and FGR as candidates. The former (AGF) is not a rule, because in FGR, G is directly followed by R, and not F, and event A does preceed G. The latter (FGR) is a rule because in AGF (the only other sequence with G), although what follows G is not R, F does not precede G. For R, the following candidate segments would be identified: GRY,FRY,PRY. This would lead to the observation that each of these candidates is an ECA rule as there is no sequence with R not followed by Y. For a less degenerate example, consider P, which has the following candidate sequences: MPR,MPQ,LPR,NPR, and OPQ. The first two disprove each other as a rule. LPR is an ECA rule, as any trace that follows P with something other than R (BJMPQZ,COPQZ,DOPQZ) has no L before P. NPR is also a rule. OPQ is a rule because the only traces with P followed by something other than Q (in this case only R) does not include O. Thus by simple iteration of neighbouring sequences, the two sets of rules can be derived. These rules were mined in both directions, to generate disjunctive rules for each task consisting of the tasks that came before it, and ECA rules of the form A←C←E.

With these two sets of rules mined, the rule base can be generated to express a great deal more about the causal nature of activity in a workflow than can the simpler disjunctive task successor rules, since disjunctive task successor rules can become less useful when events are both preceded and followed by multiple events. Once the two sets of rules are completed, binary resolution is employed to infer new rules, to augment the rule base, resulting in a sufficiently representative rule set, in most cases.

Binary resolution is a known technique for deriving consequences from multiple logical rules, having the effect of determining relations between the terms (tasks) that are not adjacent. Binary resolution typically involves translating each implication into disjunctive or conjunctive terms as per a known form (conjunctive normal form, Horn clauses, etc.) and pair-wise summing terms with the corresponding binary operator. The resulting statements may be translated back into implicative form.

As is well known in the art, if one starts out with N rules, there are on the order of N² pairs of rules that can be subjected to binary resolution. If you consider the complete case of applying binary resolution in multiple steps to any number of rules, a number on the order of 2^{N} sets of rules (subsets of the N) are possible. While generally only a fraction of these will bear new rules, as there may be many ECA and task successor rules mined, complete analysis may result in generation of too many rules, that would make the rule base rather crowded. Prior to binary resolution, to cut down on the number of possibilities, rules that are strictly subsumed by other rules may be eliminated from the list. By way of example, each of F→(R→Y), G→(R→Y), and P→(R→Y), are logically subsumed by the rule R→Y, and only the latter rule would be retained for the binary resolution. It is known in the art how to identify such relations. Other rules may also be removed, such as disjunctive rules having more than 4 or 5 terms.

There are techniques known in the automated theorem proving arts (see e.g. http://www.cs.unb.ca/˜bspencer/bspencer_homefiles/cade98-jdh-bs.pdf) for choosing clauses to resolve. For example, one may only resolve groups of rules that collectively have 3 or fewer terms, or that have a high ratio of repeated terms to total terms. In the present example, binary resolution was not applied to sets of rules that included some forward directed rules and some reverse directed rules.

One useful example of binary resolution is: A→G→F (=−A [symbol] −G [symbol] F) and A→G,F (=−A [symbol] G [symbol] F) yield −A [symbol] F (=A→F). The rule A→F is the resolvent. This rule cannot be derived from either the disjunctive mining or the ECA mining alone. Other such examples are G->RF, F->(G->R)=>G->R, and S<-U, (N<-S)<-U=>N<-U.

Even with the removal of initially subsumed rules, it is preferred to evaluate each resolvent for inclusion in the rule base, or apply filters for removing excess rules, especially complicated (many term) rules. While many algorithms exist, the particular application to rule bases with sequence-encoded orders of terms, make some algorithms better than others. For example, the binary resolution of F→R and R→Y leads to F→Y. It may be advantageous to not include F→Y in the rule base, as it may provide an impression that F is directly followed by Y, and the rules may be relied upon to provide ordering information. Similarly rules generated by a nested transitivity (e.g. L→(P→R), and L→PV, would yield L→RV). In general there are many ways to choose rule forms to present the same information and different canons can be used to select rules for inclusion. Application of these methods will yield a complete list of rules such as:

| | | | |
|---|---|---|---|
| A → F | C → NO | C → (T → W) | D → O E → N F → R |
| A → G | K → LM | E → (N → S) | I → M J → M Q → Z |
| G → R | L → PV | N → (P → R) | R → Y U → Y V → Y |
| H → I | P → QR | O → (P → Q) | W → Y X → Y Y → Z |
| M → P | S → TU | O → PSV A ← F | B ← J C ← U |
| A ← G | B ← M | E → (T → X) | B ← H B ← K N ← U |

It will be noted that this list is not exhaustive. For example, E←X is not listed. As the method seeks first relations between neighbouring tasks, and E and X are separated by 3 other tasks, such a rule is less likely to be discovered. This assumes that long-distance relations are more likely to be coincidental and less likely to exhibit meaningful dependencies. However, in cases where dependent tasks are expected to span longer distances, rule discovery parameters could be adjusted to favour identification of such rules. This list includes mostly rules relating only 2 tasks, and a complete listing of the rules implicit in this event log has a small fraction of rules relating relatively few tasks (such as 2 tasks if the traces have an average of 6 tasks (5-8)). It will also be noted that for each rule, the tasks they relate are separated in the traces by an average of less than 1 task, whereas the mean separation of tasks in the traces is well over 1. Accordingly there are a disproportionate number of rules relating fewer tasks compared with the average.

2) The mined rules can then be used to construct the abductive workflow for MN. The idea behind the abductive workflow is the assumption that M and N are not performed without a purpose, i.e. that something caused the need for performing each of the tasks. Such catalysts may precede the events (i.e. in the case that the early activity causes the later activity) or be planned to succeed the events (i.e. in the case that the later activity requires the presence of the early activity). The fact that the catalysts may not be explicitly known to the source of the query may be due to a number of factors, such as the catalyst not being recorded, being skipped intentionally or unintentionally, or that the catalyst has not yet occurred, and M and N are required tasks for some greater purpose that may be unknown or simply not of concern to the user. It may also be the case that M and N have not yet been performed, but are instead set as goals for the user. In this case, the user may wish to have a complete plan for executing this activity, ensuring that it is not done without reason. The purpose of an abductive workflow for a segment of activity is to demonstrate a workflow that will necessarily cause that activity to occur, based on the rules that have been mined from the data.

The abductive workflow for MN is built by first identifying what activity would cause MN to occur, i.e. gathering rules that imply M and/or N. Specifically the rules E N, I→M, J→M, and N←U all “point to” M or N. No rule points to M and then N. Rules like K→LM, and C→NO are not taken by the present system to explain N or M because of the lack of particularity with which the observed tasks are implied: N or M are not necessitated by such rules. So in this case, there are four “abduced tasks”: two explanations for M, and two for N. In some embodiments, multiple candidate workflows can be generated, each assuming a different collection of non-empty sets of abduced tasks for the query tasks or sequence of tasks (in our case M and N). For example, the set of abduced tasks for each candidate workflow may be {{EI},{EJ},{EIJ},{IU},{JU},{IJU}, {EIU},{EJU},{EIJU}}. Furthermore, these candidates may be ranked according to the weights of their respective rules. It will be noted that by selecting the most complete set of explanations, a most detailed workflow can be presented, and this may be the default, as is assumed in the present example. If the workflow is too detailed to be comprehensible, as may occur if there are too many competing explanations, it may be preferable to limit the number of abduced tasks. For example, to cull the candidate abbuced tasks to a desirable set, each abduced task may be independently scored, and/or ranked, and the selection of abduced tasks to add to the candidate workflow may be performed according to a number of rules, which may depend on the information available to qualify the tasks and their interrelation. Particularly noted for selection are abduced tasks that conform best with the totality of the tasks in the scenario (MN), for example by being most exemplified in the log, or having a highest occurrence of agreed tasks in the log sequences, or a highest probability of matching the log sequence.

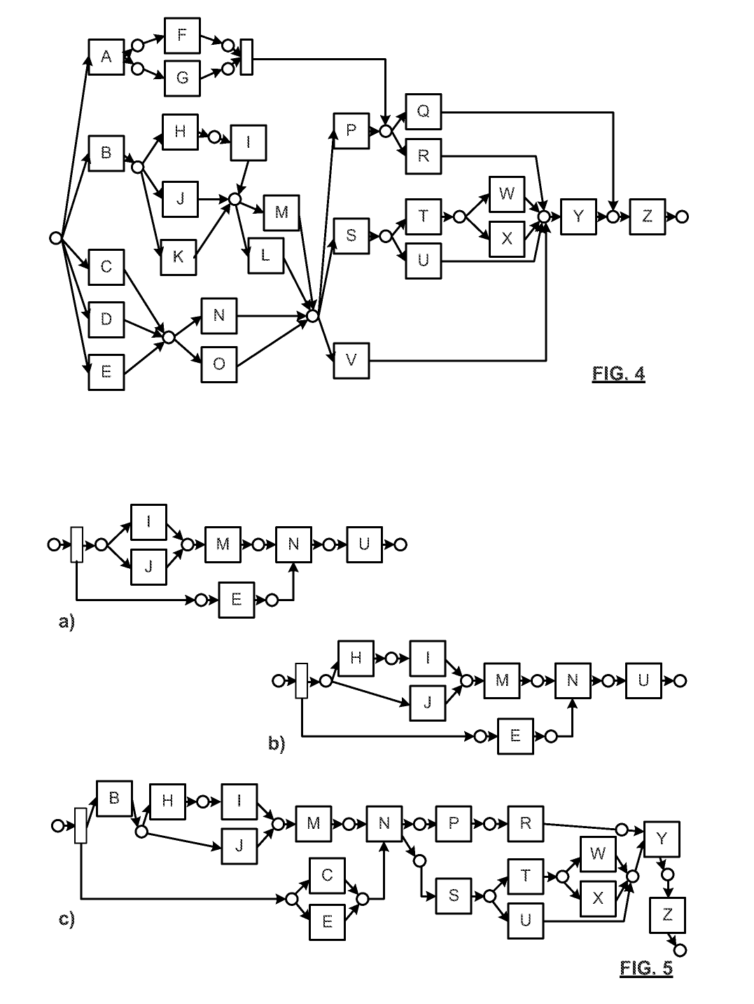

The workflow begins with assumptions: M, N, with M [symbol] N. When adding tasks to the workflow: all tasks that are consequences of M, N, or M [symbol] N, are said to be enforced; all abduced tasks for a given activity are taken as alternatives (since we only need one to occur to cause the activity), unless there is a rule that orders the alternatives in series; and if two alternatives are enforced or suggested independently (i.e. suggested or enforced by different abduced tasks, or different assumptions), and there is no rule ordering two alternatives, they are set to be concurrent. Then any element that is added to it, is added in a way that is most consistent with the rule base. One task is added at a time to the workflow by a process modeler. As I and J are both equally viable explanations for M, preceding M as per their rules, they precede M (and therefore N) in the workflow as alternatives. As for explanations for N, U comes after N, and so is after N in the workflow. Either U or E should be added, in order to explain N. As explanations for both M and N are sought, E is assigned to be concurrent with I, J, and M. The result is the workflow shown in FIG. 5a. There is no guarantee that abduced tasks will exist for any given set of assumptions, nor that their assumptions and their consequences are consistent, and so the process would require that the assumptions be valid first and foremost, and that abduced tasks are added to the extent that they are consistent with the assumptions and the rule base. There are various schemes for prioritizing or weighting the rules and abductive tasks that can be used to generate various workflows for the assumptions, as will be appreciated by those of skill in the art.

The workflow of FIG. 5a constitutes an abductive workflow since any of the firing sequences covered by the workflow (namely: IMENU, JMENU, IEMNU, JEMNU, EIMNU, EJMNU) necessarily causes or requires M and N in that: if M or N were removed or replaced in any one of these firing sequences, it would cause a violation of one of the rules (specifically the rules that point to M or N).

While the workflow of FIG. 5a constitutes an abductive workflow for MN, it is not yet self-explaining. That is, while M and N are explained, the tasks (EIJU) added to the model to explain MN, are not themselves explained. In order to have a self-explained model, all activity in the model is preferably explained, whenever explanations exist. Currently M and N are explained, leaving I, J, E and U. To explain I, it bears noting the rule H→I, and that no other rules “point to” I, J, E or U. Consequently FIG. 5b shows an abductive workflow that is self-explaining with respect to the rules mined. Note that if there is no explanation for the tasks in the query sequence, the query sequence is automatically self-explaining.

The self-explaining workflow need not substantially conform with the rules, as only a few rules were used to generate it. So next, a rule-based process modeler is used to construct a process model that is consistent with all of the rules. Depending on the application, it may be desirable to construct a workflow based on the self-explaining workflow, that is more consistent with the rule base. For example, in the above model, U→Y will be violated, since no execution of U will be followed by Y. Thus the workflow may be augmented according to the rules to make it more consistent with the existing rule base. However, making the workflow consistent with all of the rules, may make the workflow unduly complicated, and the workflow may no longer be abductive. In some examples, not only is abductivity lost, the resulting workflow may include traces that do not provide any available explanations (abduced tasks) for certain assumptions, even when such abduced tasks were initially identified. In general, if primacy is given to the rule base, and every rule is enforced regardless of its impact on the abductivity or clarity of the workflow, a workflow generated from the rules may look exactly like a subnet of the starting Petri net in which the following tasks (transitions, and their associated places and arcs when necessary) are removed: all the tasks that are not before or after M and not before or after N, (A,F,G,L,O in the present example) or any other task that was only present because of one or more removed tasks (in the present example D, which is unnecessary given that O is removed, and V, which is unnecessary as both L and O are removed). On the other hand, the self-explaining workflow is itself inconsistent with the rules in numerous ways that would not be desired, and that do not even conflict with the abductivity of the workflow. At least every modification to the self-explaining workflow that does not conflict with abductivity would improve the consistency of the workflow.

Accordingly, in some embodiments, an abductive workflow may be iteratively modified to make it maximally consistent with the rule base, without losing abductivity. In others, it may be iteratively modified to make it maximally consistent with the rule base, without losing explanations for one or more or all of the assumptions. In some embodiments, rules may be ordered, and abductivity may be lost only to make the workflow consistent with higher priority rules. For example, the starting premises (M, N, M [symbol] N) may be the top level rules, followed by user generated rules, followed by rules inferred from the event log. With such an ordering of rules, it can be ensured that only rules that are user generated can trump abductivity or existence of explanations of the workflow. In the present example, it is preferred to go further than maximal consistency of the abductive workflow, and therefore to possibly lose abductivity, without making the workflow exactly consistent with all of the rules in the rule base, and without losing abduced tasks. Specifically, Applicant uses the related notions of allowability and validity to identify how far to let the rules modify the self-explaining workflow.

A workflow is said to be valid for a rule set R if every rule in R is allowable, where the term allowable is defined as follows: a rule t₁→(t₂→( . . . (tₙ→H)) . . . ) is allowable in a workflow w if either 1) for all hεH there exists a firing sequence through w that includes the sequence t₁, t₂, . . . tₙ, h, or 2) there exists no firing sequence that includes the sequence t₁, t₂, . . . tₙ. So if the tail can be executed in the workflow, then the head can be executed as well, in the same process instance. Similarly rules of the form ( . . . ((H←tₙ) . . . )←t₂)←t₁) are allowable if the sequence h, tₙ, tₙ₋₁, . . . t₁ exists for all hεH, or the sequence tₙ, tₙ₋₁, . . . t₁ does not exist. Note that as per the standard mathematical definition of sequence, other elements that are not part of the sequence may reside within. Also note that we assume that the rule base is free of subsumed rules, in that A→BC is not in the rule base if the rule base already contained A→B, for example. So for example, in a workflow that comprises doing A or B, and then doing C or D, the rules A→D and AB←D would both be allowable, while A→E and C→A would not. If A→D had actually been a rule for that workflow, it would require extra nodes and arcs in the graph to ensure that only D would be enabled after A is executed. Allowability, a weaker notion than enforcement, is taken for the case of simplicity and readability of the resulting process model. Thus we only ensure that it is possible to execute D after A, even though the model also makes it possible to execute C instead, which would violate A→D.

In accordance with the present example, the abductive workflow is made valid by augmenting it in such a way as to make all rules in the rule base allowable. Returning to the example, any rules that are not valid with the workflow are taken in turn and used to add tasks to the workflow. The rule-based process modeler therefore iteratively creates a process model in which all input rules are allowable. This process is referred to as closing the process model. Since changing the model to make some rules allowable may make other rules unallowable as a result, the process of adding rules is done iteratively until no further augmentation is required. In the running example, this results in the following rules being used:

| | | | |
|---|---|---|---|
| M → P | B ← M | E → (N → S) | U → Y C ← U |
| Y → Z | S → TU | N → (P → R) | |
| R → Y | E → (T → X) | C → (T → W) | |
| X → Y | W → Y | | |

In a first pass, the top row of rules directly contradict the workflow of FIG. 5b. To make the workflow valid, P,B,S,Y and C are added, the same way as described above. Specifically, B and P are enforced (as consequences of the observations), while S is suggested by E, and C and Y by U. C is added as an alternative to E because U is an alternative to E, and so it is not required that both E and C be performed. The rule base provides for partial ordering of the added tasks. As P is required by M, and U (or E and therefore S) by N, both P and U/S are required, and these are made concurrent. In the second row, Z is added as following from the U suggestion (via Y), and R is enforced as per enforced N, and P. Also T is added to make S→TU allowable, as S is suggested by the abduced E. In the third row, Y is made enforced, and as T is suggested, X and W are added. In the final row, nothing is added as Y was already enforced.

The illustrated example shows the currently preferred method for generating a workflow from a set of assumptions and a rule base, with care taken not to lose abduced tasks, and to include all allowable options. A variety of alternative methods can be used to generate process models from a rule base, and some may have particular advantages in applications having different features.

The process model generated by closing the workflow is illustrated in FIG. 5c. The query source may receive this process model, at which point the source might optionally investigate what actions may have been executed prior to M and N to determine the causes, and then continue the process according to the model. The new process model may be incorporated into the base process model for subsequent queries, especially if the query is based on actual case activity. Of course this actual case activity may prompt revision of the process model independently.

If the query source determines that C had previously been executed, and that E had not, the query source may infer, or obtain evidence corroborating that B, followed by H and then I, or J, were executed prior to M, and accordingly may continue the process by executing S and U, and P and R in parallel. The option of executing T instead of U would disappear, due to the fact that U would be the lone catalyst for N. If E is determined to have occurred, and not C for this case ceteris paribus, the process may continue by executing S followed by U or T, and in parallel, P and then R. The option of executing W after T would disappear, due to the existence of E→(T→X) and the absence of C to enforce C→(T→W).

If the query source determines that there were no other possible activities occurring other than MN, the process modeler may be requested to repeat the process not allowing for any prior events to MN. As such, the process modeler will start with MN, and find the only explanation for any part of MN is U. Then as U requires C, and C comes before N, U is discounted, although in other embodiments, the rule may be given less weight than the abduced task. Thus MN is the self-explained workflow. Closing this workflow will only require these 4 rules: N→(P→R), M→P, R→Y and Y→Z. The closed model will be a chain: M N P R Y Z.

Depending on what information states the query source and abductive workflow miner are expected to have, it may well make sense for the process to request the query source to indicate whether each of E, I, J and U is known or suspected to have been completed in this case, known or suspected to have not been completed, or simply unknown, prior to producing the self-explaining abductive workflow.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method for process mining, the method comprising:
accessing a base model for a process that differentiates permissible sequences of tasks within a subject process from the impermissible;
accessing a set of rules characterizing relations between tasks in an event log associated with the process;
receiving a specification of a set or sequence of tasks that together fails to complete an instance of the process according to the base model; and
applying an abductive reasoning process by a computer processor, using the set of rules and the set or sequence of tasks to identify one or more ways of completing a process instance including the set or sequence of tasks, by: identifying rules in the set that would entail one or more tasks in the process instance, and adding to the process instance one or more abduced tasks, that according to the identified rules, explain the tasks in the process instance.

2. The method of claim 1 wherein the one or more ways of completing the process instance identified by the abductive reasoning process includes at least one way of completing the process instance that is not consistent with any single trace within the event log corresponding to a completed processing instance.

3. The method of claim 1 further comprising generating the set of rules, with
the set of rules incompletely characterizing relations between tasks in the event log in that the rules are non-exhaustive;
the set of rules incompletely characterizing relations between tasks in the event log, the set of rules including proportionally more rules relating relatively few tasks than all rules implicit in the event log;
the set of rules incompletely characterizing relations between tasks in the event log, the set of rules including mostly rules relating exactly two tasks;
the set of rules incompletely characterizing relations between tasks in the event log, the set of rules including proportionally more rules relating tasks that are separated by less than a mean separation of tasks than all rules implicit in the event log; or
the set of rules incompletely characterizing relations between tasks in the event log, and includes user-defined rules.

4. The method of claim 1 wherein applying the abductive reasoning process comprises: constructing an initial model for the specified set or sequence of tasks as per the specification; growing the initial model by identifying each rule in the set that would entail at least part of the specified set or sequence if an abduced task, not in the initial model, were added, and adding such abduced tasks until a sufficiently explained model is provided, or no further explanations are available; and modifying the sufficiently explained model by iteratively modifying the model to make it more consistent with respect to the set of rules.

5. The method of claim 4 wherein applying the abductive reasoning process further comprises generating a graphical model of the process associated with the set or sequence of tasks, wherein adding abduced tasks to grow the model comprises inserting the added abduced task into the model in a way that is most consistent with the rule base.

6. The method of claim 4 wherein applying the abductive reasoning process further comprises generating a graphical model of the process associated with the set or sequence of tasks, wherein iteratively modifying the model to make it more consistent with respect to the set of rules comprises: only removing the abduced tasks if the sufficiently explained model is inconsistent with the set of rules; and iteratively inserting consistent tasks into the model in a way that is most consistent with the rule base.

7. The method of claim 1 wherein accessing the base model comprises generating the base model as a list of event-condition-action rules, or task-successor rules from a current event log using a non-exhaustive method.

8. The method of claim 1 wherein the no tasks are added to the process instance except abduced tasks that explain a task previously contained in the process instance, and tasks added to make the process instance more consistent with the base model.

9. A computer comprising a memory and processor, the memory storing in computer readable program instructions for directing the processor to implement a method according to claim 1.

10. A computer comprising a memory and processor, the memory storing in computer readable program instructions for directing the processor to implement a method according to claim 4.
